(19) United States
(12) Patent Application Publication
(10) Pub. No.: US 2007/0139286 A1
(43) Pub. Date: Jun. 21, 2007

(54) Antenna for wireless devices

(76) Inventors: Umesh D. Navsariwala, Schaumburg, IL (US); Nicholas E. Buris, Deer Park, IL (US); Mark A. Schamberger, South Elgin, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/314,215

(22) Filed: Dec. 21, 2005

(51) Int. Cl. H01Q 13/10

(52) U.S. Cl. 343/767; 343/700 MS

(57) ABSTRACT

A wireless device (102) having a slot antenna (104) is disclosed. The slot antenna includes at least one conducting element. Examples of the at least one conducting element include a Printed Circuit Board (PCB) ground, a metallized battery housing, a metallized frame of a display screen, a metallized housing of a keypad frame, and a metallized housing of the wireless device.

### FIELD OF THE INVENTION

This invention relates in general to the field of wireless devices. More specifically, the invention relates to antennas used in wireless devices.

### BACKGROUND OF THE INVENTION

During the last few decades, there has been a significant growth in the usage of wireless devices, such as mobile phones. This has resulted in developments to enhance the performance, and reduce the size of the wireless devices. One such area of development has been in the field of antennas, used in the wireless devices. The shape and size of an antenna, whether an internal antenna or an external antenna, influences the size and performance of a wireless device.

Considering the constraint of reducing size of the wireless devices, more compact antennas are required that consume less volume. Further, the antenna's performance needs to be improved, to enhance the performance of the device. The challenge of providing enhanced performance with a smaller antenna has become an issue that needs to be resolved.

The performance of a wireless device can be effectively enhanced by an external antenna. However, an external antenna requires extra volume in a device, and is also more prone to damage. Antenna damage can be avoided by using an internal antenna. However, an internal antenna occupies space in a wireless device. Further, the internal antenna needs to be properly isolated from the other electronic components of the wireless device, to avoid interference in the operations of the internal antenna. These factors tend to increase the overall size of the wireless device.

### BRIEF DESCRIPTION OF THE FIGURES

The present invention is illustrated by way of an example, and not limitation in the accompanying figures, in which like references indicate similar elements, and in which:

FIG. 1 depicts an exemplary wireless device, in accordance with an embodiment of the invention;

FIG. 2 depicts an exemplary wireless device, in accordance with another embodiment of the invention;

FIG. 3 depicts a return-loss plot of an exemplary antenna, in accordance with an embodiment of the invention; and

FIG. 4 depicts an exemplary wireless device, in accordance with yet another embodiment of the invention.

Skilled artisans will appreciate that elements in the figures are illustrated for simplicity and clarity and have not necessarily been drawn to scale. For example, the dimensions of some of the elements in the figures may be exaggerated relative to other elements, to aid in understanding embodiments of the present invention.

### DETAILED DESCRIPTION OF DRAWINGS

Before describing in detail the particular antenna for wireless devices, in accordance with the present invention, it should be observed that the present invention resides primarily in combinations of apparatus components related to the antenna for wireless devices. Accordingly, the apparatus components have been represented where appropriate by conventional symbols in the drawings. These show only the specific details that are pertinent for an understanding of the present invention, so as not to obscure the disclosure with details that will be readily apparent to those of ordinary skill in the art, with the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The term “another,” as used herein, is defined as at least a second or more. The terms “including” and/or “having,” as used herein, are defined as comprising. The term “coupled,” as used herein is defined as connected although not necessarily directly, and not necessarily mechanically.

In an embodiment of the present invention, a wireless device having a slot antenna is provided. Examples of the wireless device include, but are not limited to, a mobile phone, a Personal Digital Assistant (PDA), a gaming device, a wireless controller, and a laptop.

Various embodiments of the present invention provide a wireless device having a slot antenna. The slot antenna includes at least one conducting element. Examples of the at least one conducting element include a Printed Circuit Board (PCB) ground, a metallized battery housing, a metallized frame of a display screen, a metallized housing of a keypad frame, and a metallized housing of the wireless device. In another embodiment, the wireless device includes a flip part and a base part. The flip part includes a first conducting element, and the base part includes a second conducting element. The wireless device further includes a third conducting element, which electrically couples the first conducting element and the second conducting element. Further, the first conducting element, the second conducing element, and the third conducting element together form a slot antenna for the wireless device.

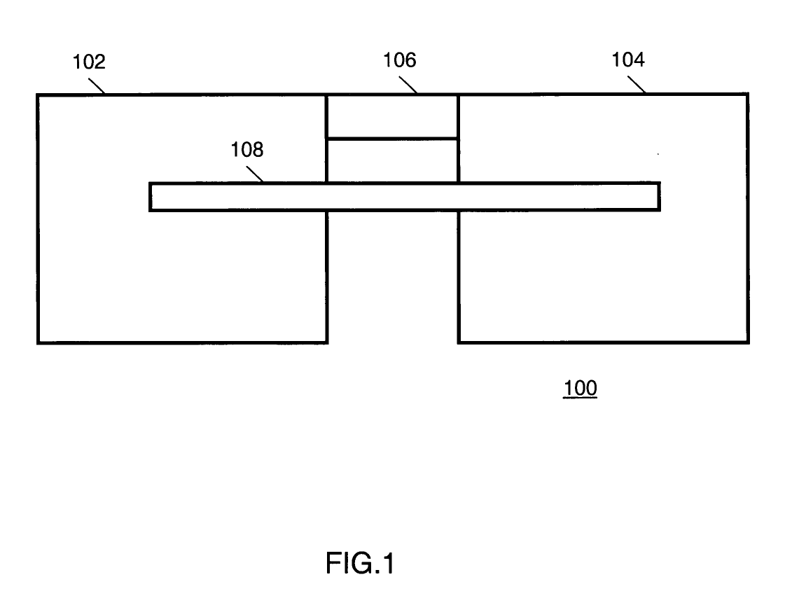

FIG. 1 depicts an exemplary wireless device 102, in accordance with an embodiment of the invention. Examples of the wireless device 102 include, but are not limited to, a mobile phone, a Personal Digital Assistant (PDA), a gaming device, a wireless controller, and a laptop. The wireless device 102 has a slot antenna 104. The slot antenna 104 includes at least one conducting element 106. Examples of the at least one conducting element 106 include, but are not limited to, a Printed Circuit Board (PCB) ground, a metallized battery housing, a metallized frame of a display screen, a metallized housing of a keypad frame, and a metallized housing of the wireless device 102. The wireless device 102 also includes a feed line 108 for activating the slot antenna 104. The slot antenna 104 can be activated by exciting it with a radio frequency electric signal transmitted over the feed line 108. In an embodiment, the feed line 108 is capacitatively coupled to the slot antenna 104. The feed line 108 carries the radio frequency electric signal to the slot antenna 104. Examples of the feed line 108 include, but are not limited to, a coaxial cable, a microstrip line, a slot line, a coplanar waveguide, or a parallel transmission line. In an embodiment, one of the ends of the feed line 108 can be connected to a signal feeding and reception module used for processing signals that are transmitted and received by the slot antenna 104. The other end of the feed line 108 is connected to the slot antenna 104, and can be appropriately adjusted to tune the slot antenna 104. The slot antenna 104 can be tuned to have a resonant frequency in a band of interest, for example, a 1900 MHz frequency band.

In another embodiment, the slot antenna 104 includes one or more slots, and one or more feed lines, associated with each slot. The slots and the feed lines associated with the slots are reconfigurable through one or more switches. Examples of the one or more switches include but are not limited to electrical switches, mechanical switches, and electro-mechanical switches.

In an embodiment, the wireless device 102 can also include at least one additional antenna, for example, a Planar Inverted-F Antenna (PIFA), a Folded-J Antenna (FJA), a monopole antenna, Inverted-F Antenna (IFA), or a loop antenna. An example of an FJA antenna may be seen in U.S. patent application Ser. No. 10/873,870, assigned to the same assignee as the present invention. The additional antenna can be used in a diversity configuration with the slot antenna 104. In an embodiment, the slot antenna 104 can be tuned to resonate at a high frequency, for example, 1900 MHz, and the additional antenna can be tuned to resonate at a low frequency, for example, 850 MHz in the diversity configuration.

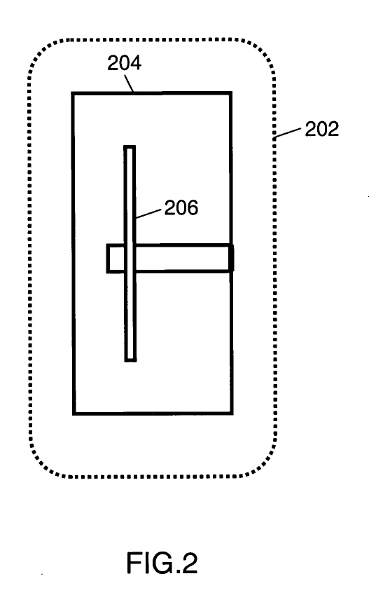

FIG. 2 depicts an exemplary wireless device 200, in accordance with another embodiment of the invention. Examples of the wireless device 200 include, but are not limited to, a mobile phone, a Personal Digital Assistant (PDA), a gaming device, a wireless controller, and a laptop. The wireless device 200 includes a flip part 202 and a base part 204. The flip part 202 and the base part 204 can be arranged in a first position and a second position. The first position can be, for example, a ‘flip-open’ position and the second position can be, for example, a ‘flip-closed’ position. The wireless device 200 also includes a first conducting element 206 in the flip part 202, and a second conducting element 208 in the base part 204. Examples of the first conducting element 206 and the second conducting element 208 include, but are not limited to, a Printed Circuit Board (PCB) ground, a metallized battery housing, a metallized frame of the display screen, a metallized housing of a keypad frame, and a metallized housing of the wireless device 200. The wireless device 200 also includes a third conducting element 210, which electrically connects the first conducting element 206 with the second conducting element 208. Examples of the third conducting element 210 include, but are not limited to, a metallized hinge that is capable of mechanically coupling the flip part 202 with the base part 204, and a flexible circuit that is capable of electrically coupling the circuitry in the flip part 202 with the circuitry in the base part 204. In this embodiment, the first conducting element 206, the second conducting element 208, and the third conducting element 210 together form a slot antenna 212 for the wireless device 200.

The wireless device 200 further includes a feed line 214 for activating the slot antenna 212. Examples of feed line 214 include, but are not limited to, a coaxial cable, a microstrip line, a slot line, a coplanar waveguide, or a parallel transmission line. In an embodiment the feed line 214 is capacitatively coupled to the slot antenna 212. The slot antenna 212 can be activated by exciting it with a radio frequency electric signal transmitted over the feed line 214. In an embodiment, one of the ends of the feed line 214 can be connected to a signal feeding and reception module, used for processing signals transmitted and received by the slot antenna 212. Further, the other end of the feed line 214 is coupled to the slot antenna 212, and can be appropriately adjusted to tune the slot antenna 212 to have a resonant frequency in a band of interest, for example, a 1900 MHz frequency band.

The wireless device 200 can also include a switch (not shown in FIG. 2). The switch is capable of activating the slot antenna 212 when the wireless device 200 is in the ‘flip-closed’ position. An example of the switch includes, but is not limited to, a switched grounded transmission line stub. The switch can be used to enhance the performance of the slot antenna 212 in the ‘flip-closed’ position with the help of additional capacitance formed between the flip part 202 and the base part 204. The additional capacitance helps in tuning the resonant frequency of the slot antenna 212 in the desired frequency band.

In another embodiment, the slot antenna 212 includes one or more slots, and one or more feed lines, associated with each slot. The slots and the feed lines associated with the slots are reconfigurable through one or more switches. Examples of the one or more switches include, but are not limited to, electrical switches, mechanical switches, or electro-mechanical switches.

In an embodiment, the wireless device 200 can also include at least one additional antenna, for example, a Planar Inverted-F Antenna (PIFA), a monopole antenna, a loop antenna, Inverted-F Antenna (IFA), or a Folded-J Antenna (FJA). The additional antenna can be used in a diversity configuration with the slot antenna 212. In an embodiment, the slot antenna 212 can be tuned to resonate at a high frequency, for example, 1900 MHz, and the additional antenna can be tuned to resonate at a low frequency, for example, 850 MHz, in the diversity configuration.

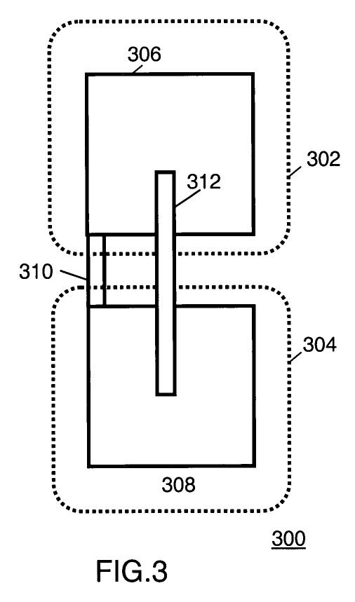

FIG. 3 depicts a return-loss plot 300 of the antenna shown in FIG. 2, in accordance with an embodiment of the invention. The return-loss is the power returned from an antenna. It is desired for an antenna to have low return loss. The return-loss plot 300 shows the return-loss of the antenna described in FIG. 2 in a ‘flip-open’ position and a ‘flip-closed’ position, determined over a frequency range of 500 MHz to 2500 MHz. The return-loss in the ‘flip-open’ position is depicted by using circles. The return loss in the ‘flip-closed’ position is depicted by using squares. The return-loss plot 300 in the ‘flip-open’ position exhibits two resonant frequencies, centered approximately at 850 MHz and 1900 MHz. Hence, a dual-band performance is observed for the slot antenna in the ‘flip-open’ position. The return-loss plot 300 also depicts the performance degradation of the antenna in the flip closed position, since there is no resonant frequency observed in the plot for the low band. This illustrates the need for tuning the antenna with a switch and capacitances in the flip closed position, as described above.

The return-loss plot 300 is plotted by using a simple prototype model of the antenna described in FIG. 2. The prototype model is constructed by using two rectangular Printed Circuit Boards (PCBs). Each of the PCBs used has a dimension of 50 mm×75 mm. The PCBs can be used to represent the first conducting element 206 and the second conducting element 208 of the wireless device 200. Further, a copper tape segment is used to represent the third conducting element 210. The width of the slot between the PCBs is set as 8 mm. This slot is excited by using a copper tape line on a 0.5 mm thick substrate. It should be noted that the above mentioned details of the prototype model are exemplary and other variations of the prototype model described are also possible.

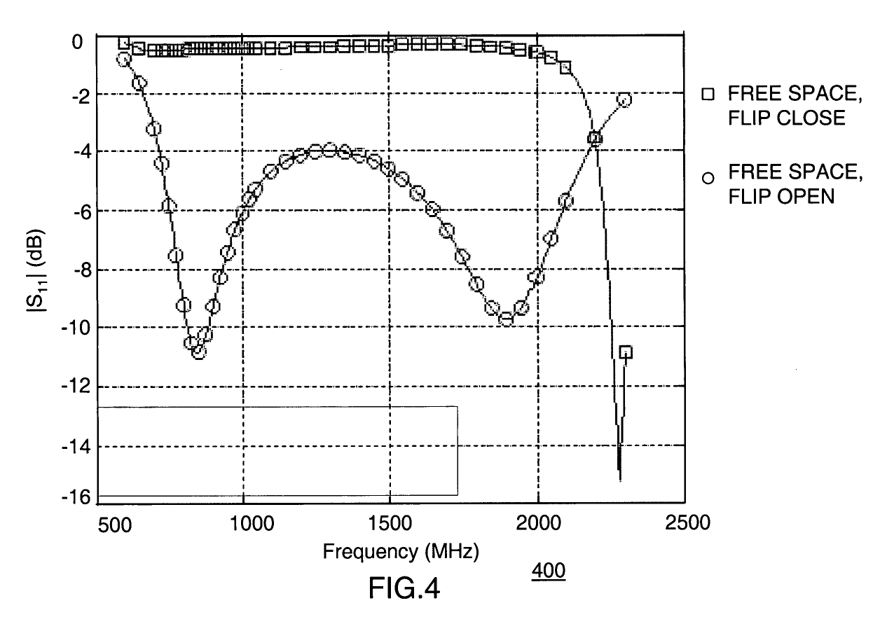

FIG. 4 depicts an exemplary wireless device 400, in accordance with yet another embodiment of the invention. Examples of the wireless device 400 include, but are not limited to, a mobile phone, a Personal Digital Assistant (PDA), a gaming device, a wireless controller, and a laptop. The wireless device 400 includes a flip part 402 and a base part 404. The flip part 402 and the base part 404 can be arranged in a first position and a second position. The first position can be, for example, a ‘flip-open’ position and the second position can be, for example, a ‘flip-closed’ position. The wireless device 400 also includes a first conducting element 406 in the flip part 402, and a second conducting element 408 in the base part 404. Examples of the first conducting element 406 and the second conducting element 408 include, but are not limited to, a Printed Circuit Board (PCB) ground, a metallized battery housing, a metallized frame of the display screen, a metallized housing of a keypad frame, and a metallized housing of the wireless device 400. The wireless device 400 also includes a third conducting element 410, which electrically connects the first conducting element 406 with the second conducting element 408. Examples of the third conducting element 410 include, but are not limited to, a metallized hinge that is capable of mechanically coupling the flip part 402 with the base part 404, and a flexible circuit that is capable of electrically coupling the circuitry in the flip part 402 with the circuitry in the base part 404. The first conducting element 406, the second conducting element 408, and the third conducting element 410 together form a slot antenna 412 for the wireless device 400. Further, the wireless device 400 includes a reconfiguration switch 414, which electrically connects the first conducting element 406 with the second conducting element 408. Examples of the reconfiguration switched 414 include, but are not limited to, a diode RF switch, an electrical switch, an electromechanical switch, and a mechanical switch. The first conducting element 406, the second conducting element 408, and the reconfiguration switch 414 together forms a slot antenna 416 for the wireless device 400. The reconfiguration switch 414 can be used for selecting one or more of the slot antennas 412 and 416 for transmitting and receiving signals. In the open position of the reconfiguration switch 414, the slot antennas 412 and 416 can be selected for transmitting and receiving signals for the wireless device 400. In the closed position of the reconfiguration switch 414, the slot antenna 416 can be selected for transmitting and receiving signals for the wireless device 400.

The wireless device 400 further includes a first feed line 418 and a second feed line 420 for activating the slot antennas 412 and 416 respectively. Examples of the first feed line 418 and the second feed line 420 include, but are not limited to, a coaxial cable, a microstrip line, a slot line, a coplanar waveguide, or a parallel transmission line. In an embodiment the first feed line 418 and the second feed line 420 can be capacitively coupled to the slot antennas 412 and 416 respectively. The slot antennas 412 and 416 can be activated by exciting them with a radio frequency electric signal transmitted over the feed lines 418 and 420 respectively. In an embodiment, one end of the feed lines 418 and 420 can be connected to a signal feeding and reception module, used for processing signals transmitted and received by the slot antennas 412 and 416. Further, the other end of the feed lines 418 and 420 is coupled to the slot antennas 412 and 416 respectively, and can be appropriately adjusted to tune the slot antennas 412 and 416 to have a resonant frequency in a band of interest, for example, a 1900 MHz frequency band.

Various embodiments of the invention have the following advantages. Various portions of a wireless device, for example, the Printed Circuit Board (PCB) and other internal metallic components, can be utilized to form a slot antenna for the wireless device. As a result, cost-saving pertaining to the wireless device can be realized by using the present invention. Further, the space required by an antenna in a wireless device can be reduced, which, in turn, would reduce the size of the wireless device. The space saved can be utilized by, for example, having at least one additional antenna in the wireless device.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A wireless device having a slot antenna, the slot antenna comprising at least one conducting element, wherein the at least one conducting element is selected from a group comprising a Printed Circuit Board (PCB) ground, a metallized battery housing, a metallized frame of a display screen, a metallized housing of a keypad frame, and a metallized housing of the wireless device.

2. A wireless device as defined in claim 1 further comprising a feed line, wherein the feed line is used for activating the slot antenna.

3. A wireless device as defined in claim 2, wherein the feed line is capacitively coupled to the slot antenna.

4. A wireless device as defined in claim 2, wherein the feed line is selected from a group comprising a coaxial cable, a microstrip line, a slot line, a coplanar waveguide, and a parallel transmission line.

5. A wireless device as defined in claim 1 further comprising at least one additional antenna.

6. A wireless device as defined in claim 5, wherein the at least one additional antenna is selected from a group comprising a Planar Inverted-F Antenna (PIFA), an Inverted-F Antenna (IFA), a Folded-J Antenna (FJA), a monopole antenna, and a loop antenna.

7. A wireless device as defined in claim 1, wherein the slot antenna further comprises:
one or more slots; and
one or more feed lines associated with the one or more slots for activating the one or more slots.

8. A wireless device as defined in claim 7, wherein the one or more slots and the one or more feed lines are reconfigurable through one or more switches.

9. A wireless device as defined in claim 8, wherein the one or more switches are selected from a group comprising electrical switches, mechanical switches, and electro-mechanical switches.

10. A wireless device as defined in claim 1, wherein the wireless device is selected from a group comprising a mobile phone, a Personal Digital Assistant (PDA), a gaming device, a wireless controller, and a laptop.

11. A wireless device having a flip part and a base part, the flip part and the base part capable of being arranged in a first position and a second position, the wireless device comprising:
a first conducting element in the flip part;
a second conducting element in the base part; and
a third conducting element, the third conducting element being electrically coupled to the first conducting element and the second conducting element, wherein the first conducting element, the second conducting element and the third conducting element form a slot antenna.

12. A wireless device as defined in claim 11 further comprising a feed line, wherein the feed line is used for activating the slot antenna.

13. A wireless device as defined in claim 12, wherein the feed line is capacitively coupled to the slot antenna.

14. A wireless device as defined in claim 12, wherein the feed line is selected from a group comprising a coaxial cable, a microstrip line, a slot line, a coplanar waveguide, and a parallel transmission line.

15. A wireless device as defined in claim 11, wherein the slot antenna comprises:
one or more slots; and
one or more feed lines associated with the one or more slots, for activating the one or more slots.

16. A wireless device as defined in claim 15, wherein the one or more slots and the one or more feed lines are reconfigurable through one or more switches.

17. A wireless device as defined in claim 11, wherein the third conducting element is selected from a group comprising a metallized hinge mechanically coupling the flip part and the base part and a circuit electrically coupling a circuitry in the flip part and a circuitry in the base part.

18. A wireless device as defined in claim 11, wherein the first conducting element and the second conducting element are selected from a group comprising a Printed Circuit Board (PCB) ground, a metallized battery housing, a metallized frame of a display screen, a metallized housing of a keypad frame, and a metallized housing of the wireless device.

19. A wireless device as defined in claim 11 further comprising at least one additional antenna.

20. A wireless device as defined in claim 19, wherein the at least one additional antenna is selected from a group comprising a Planar Inverted-F Antenna (PIFA), an Inverted-F Antenna (IFA), a Folded-J Antenna (FJA), a monopole antenna, and a loop antenna.

21. A wireless device as defined in claim 11, wherein the first position is a flip-open position, and the second position is a flip-closed position.

22. A wireless device as defined in claim 11, wherein the wireless device is selected from a group comprising a mobile phone, a Personal Digital Assistant (PDA), a gaming device, a wireless controller, and a laptop.
